(19) United States
(12) Patent Application Publication
(10) Pub. No.: US 2019/0185768 A1
(43) Pub. Date: Jun. 20, 2019

(54) METHOD FOR HYDROTREATMENT OF VACUUM DISTILLATES IMPLEMENTING A SPECIFIC CONCATENATION OF CATALYSTS

(71) Applicant: IFP Energies nouvelles, Rueil-Malmaison Cedex (FR)

(72) Inventors: Thibaut CORRE, Chaponost (FR); Alberto SILVA SERVIA, Lyon (FR); Laurent SIMON, Decines Charpieu (FR); Frederic BAZER-BACHI, Saint Privat Des Vieux (FR)

(73) Assignee: IFP Energies nouvelles, Rueil-Malmaison Cedex (FR)

(21) Appl. No.: 16/225,738

(22) Filed: Dec. 19, 2018

(30) Foreign Application Priority Data
Dec. 19, 2017 (FR) 17/62.463

(51) Int. Cl. C10G 69/04; C10G 45/08; C10G 11/18; C10G 11/02; B01J 23/882

(52) U.S. Cl. CPC C10G 69/04; B01J 2523/847; C10G 11/18; C10G 11/02; B01J 23/882; C10G 2300/4006; C10G 2300/4012; C10G 2300/4018; C10G 2300/1074; C10G 2300/202; C10G 2300/703; B01J 2523/68; B01J 2523/69; B01J 2523/845; C10G 45/08

(57) ABSTRACT

A method for hydrotreatment of a vacuum-distillate-type hydrocarbon feedstock that contains sulfur and nitrogen compounds is described, with said method for hydrotreatment of a vacuum-distillate-type feedstock comprising a specific concatenation of catalysts that makes it possible to increase the overall activity and the overall stability of the method.

### PRIOR ART AND SUMMARY OF THE INVENTION

This invention relates to the field of the methods for hydrocracking and catalytic cracking and more particularly to a pretreatment of such methods by hydrotreatment of a feedstock of vacuum distillate type by implementation of a concatenation of catalysts. The objective of the method is the production of hydrogenated, hydrodesulfurized (HDS), hydrodenitrified (HDN) and hydrodearomatized (HDA) vacuum distillates. The hydrotreatment method according to the invention is particularly suited for the hydrotreatment of feedstocks comprising high contents of sulfur and nitrogen.

The fluid catalytic cracking (FCC) method makes it possible to convert petroleum fractions, in particular vacuum distillates (DSV), into lighter and more upgradable products (gasoline, middle distillates). The vacuum distillates contain variable contents of various contaminants (sulfur compounds, nitrogen compounds, in particular): it is therefore necessary to carry out a step for hydrotreatment of the feedstock before the step for catalytic cracking itself that will make it possible to break C—C bonds and to produce the desired light fractions. The same problem exists for a feedstock intended for a hydrocracking method.

The objective of the hydrotreatment step, often called FCC pretreatment, is to purify the feedstock without excessively modifying the mean molecular weight of the latter. It is a matter in particular of eliminating the sulfur compounds or nitrogen compounds that are contained in the latter. The primary reactions that are desired are hydrodesulfurization, hydrodenitrification and hydrogenation of aromatic compounds. The composition and the use of hydrotreatment catalysts are particularly well described in the work “Catalysis by Transition Metal Sulphides” by P. Raybaud and H. Toulhoat, 2012. The hydrotreatment catalysts generally have sulfur-based hydrodesulfurizing and hydrogenating functions of metals from groups VIB and VIII.

The addition of an organic compound to the hydrotreatment catalysts to improve their activity is well known to one skilled in the art, with these catalysts often being called “additive catalysts.”

Numerous documents describe the use of various ranges of organic compounds as additives, such as organic compounds that contain nitrogen and/or organic compounds that contain oxygen and/or organic compounds that contain sulfur.

A family of organic compounds that is now well known in literature relates to the chelating nitrogen compounds (EP0181035, EP1043069 and U.S. Pat. No. 6,540,908) with, by way of example, ethylenediaminetetraacetic acid (EDTA), ethylenediamine, diethylenetriamine or nitrilotriacetic acid (NTA).

In the family of organic compounds that contain oxygen, the use of mono-, di- or poly-alcohols that are optionally etherified is described in the documents WO96/41848, WO01/76741, U.S. Pat. Nos. 4,012,340, 3,954,673, EP601722, and WO2005/035691. The prior art more rarely mentions additives that comprise ester groups (EP1046424, WO2006/077326). Other patents claim the use of carboxylic acids (EP1402948, EP0482817, FR3035600). In particular, the use of citric acid, but also of tartaric acid, butyric acid, hydroxyhexanoic acid, malic acid, gluconic acid, glyceric acid, glycolic acid, hydroxybutyric acid, γ-ketovaleric acid have been described.

Other patents show that a specific concatenation of catalysts in the same reactor can be advantageous.

The patent application US2011/0079542 describes that the replacement of a portion of an HDS reference catalyst at the top of the bed with a lower-activity catalyst does not modify the performances of the overall loading in relation to 100% of reference catalyst, because on the first portion of the catalytic bed, various limitations, such as diffusional limitations, arise.

In the patent application U.S. Pat. No. 7,597,795, a concatenation of two catalytic beds is proposed with the production of an oil base as its objective. The difference between the two catalytic beds resides in the larger amount of molybdenum of the second bed in relation to the first bed, with a condition of mean pore diameter of at least 10 nm for the catalyst of the first bed.

Finally, in the patent application FR3013720, a concatenation of two catalysts is proposed. The first catalyst is obtained in its oxide form by calcination; the second catalyst, more active, is a dried catalyst that contains at least one organic compound.

Thus, the prior art generally refers to the concatenation of a first catalyst that is not very active with one or more other catalysts that are more active because of the fact of significant limitations on the first layers of catalysts; it is not useful to use a very high-performing and often more expensive catalyst. It is in particular for this reason that the concatenation of a first calcined catalyst with a second additive catalyst of an organic compound is made, because it is known to one skilled in the art that the additive catalysts generally have an improved hydrotreatment power in relation to the non-additive catalysts.

The applicant developed a method for hydrotreatment of a feedstock of the vacuum distillate type comprising bringing said feedstock into contact with a specific concatenation of catalysts making it possible to increase the overall activity and the overall stability of the method.

Without being tied by any theory, it seems that the diffusional limitations that are observed, at the beginning, of the reactor in the first catalytic bed(s) are generally due to a problem of transferring hydrogen from the gas phase to the liquid phase. Actually, with the feedstock being in particular composed of sulfur and nitrogen molecules that are not very refractory in relative terms, they are quickly converted at the beginning of the catalytic bed, leading to rapid hydrogen depletion of the liquid phase.

The specificity of the catalyst(s) according to the invention used at first in the catalyst bed(s) is that it has a reduced mean equivalent diameter and a mean length that is reduced or equal in relation to at least one second different catalyst that is used in at least one second catalytic bed. This reduction in mean equivalent diameter, and even of the mean length, makes it possible to improve the transfer of hydrogen from gas to liquid. The first catalyst, being better supplied with hydrogen, becomes more active. In a preferred embodiment, it then becomes very advantageous to use at least one first additive catalyst in contrast to the calcined catalyst that is generally encountered in the prior art. The reduction of the mean equivalent diameter, and even of the mean length, then being able to bring about problems of operability of the method (in particular an increase in the pressure loss or pressure drop between the intake and the output of the reactor, this pressure drop being called “deltaP”), it is then advantageous that the catalyst that is used in at least one second catalytic bed has a larger mean equivalent diameter and a mean length that is greater than or equal in relation to the mean equivalent diameter and to the mean length of the catalyst that is used in the first catalytic bed so as to compensate for the increase in deltaP, which would be obtained by the use in all of the catalytic beds of the first catalyst with a mean equivalent diameter (and even with mean length) that is reduced. The first catalyst that is used in the first catalytic bed being more active, the effluents supplying the second catalyst then do not have a larger portion of their impurities, in particular the sulfur, nitrogen and aromatic compounds, thus making it possible to improve the stability of said second catalyst. Ultimately, with this specific concatenation, the overall method is either more active in terms of denitrification and desulfurization exiting from said method and more stable because the service life is extended, or more easily operable because deltaP is reduced, or more active in terms of denitrification and desulfurization and more stable and more easily operable.

### SUMMARY AND ADVANTAGE OF THE INVENTION

More particularly, this invention relates to a method for hydrotreatment of a hydrocarbon feedstock that contains nitrogen and sulfur compounds with a content that is greater than 250 ppm by weight, preferably greater than 500 ppm, and that has a weighted mean boiling point that is greater than 380° C., in which, in a way so as to obtain a hydrotreated effluent, said hydrocarbon feedstock is brought into contact, in the presence of hydrogen, with a concatenation of n catalysts advantageously used in n catalytic beds, with n being a whole number between 2 and 10, preferably between 2 and 5, in a preferred manner between 2 and 3, and in a more preferred manner n=2, with said catalysts all comprising an amorphous substrate selected from among alumina, silica and silica-alumina, by themselves or in a mixture, and an active phase comprising at least one metal from group VIB and at least one metal from group VIII, with said method being characterized in that the mean equivalent diameters and the mean lengths of catalysts that are used comply with the following equations:

1.1×d_{eq moy i}≤d_{eq moy i+1}≤2×d_{eq moy i}

l_{moy i}≤l_{moy i+1}≤2×l_{moy i}

d_{eq moy i}≤l_{moy i}

d_{eq moy i+1}≤l_{moy i+1}

in which:

d_{eq moy i}=mean equivalent diameter of the catalyst in the i^{th} position in the concatenation of n catalysts

d_{eq moy i+1}=mean equivalent diameter of the catalyst in the i+1^{th} position in the concatenation of n catalysts

l_{moy i}=mean length of the catalyst in the i^{th} position in the concatenation of n catalysts

l_{moy i+1}=mean length of the catalyst in the i+1^{th} position in the concatenation of n catalysts with i being a whole number between 1 and n−1.

The inventors have demonstrated that the transfer of hydrogen from gas to liquid was able to be improved by the implementation of a concatenation of n catalysts, with n being a whole number between 2 and 10, said catalysts having a mean equivalent diameter—and even a mean length—all the more reduced as said catalysts are placed upstream in the concatenation of n catalysts. Because of its reduced mean equivalent diameter, and even its reduced mean length, the first catalyst is better supplied with hydrogen and then becomes more active. The effluents that supply the next catalyst in the concatenation then are lacking a larger part of their impurities, in particular the sulfur, nitrogen and aromatic compounds, which makes it possible to improve the stability and the performance of said next catalyst, and so on to the last catalytic bed using the last catalyst. Ultimately, with this specific concatenation, the overall method is more active and more stable because the service life is extended.

Another advantage of said specific concatenation of n catalysts is that it makes it possible to maintain or to reduce deltaP, which makes it possible to maintain or to improve the operability of the method.

Because of its manufacturing method, the form of the catalyst is never perfectly homogeneous and systematically has a certain distribution of diameter and length.

Throughout the rest of the text, it is considered that the size and the shape of the substrate of the catalyst are equal to the size and the shape of the final catalyst.

The mean equivalent diameter of the substrate is therefore equal to the mean equivalent diameter of the final catalyst. The same holds true for the mean length.

If the catalysts come in the form of balls, the mean equivalent diameter and the mean length are equal to one another, and they are equal to the mean diameter of the circles that are circumscribed around catalyst balls.

If the catalysts come in the form of extrudates (cylindrical, trilobed, quadrilobed, . . . ), the mean equivalent diameter of said catalyst is defined as the mean diameter of the circles that are circumscribed around catalyst extrudates, and the mean length corresponds to the mean of the longer characteristic distances or the length of the catalyst extrudates.

The equivalent diameter, i.e., the diameter of the circumscribed circle, and the length of a catalyst grain (or extrudate, for example) are measured by any technique known to one skilled in the art that makes possible a granulometric and morphological analysis of solids, for example, by computer processing of images that are obtained by a tool that constitutes, for example, a camera or a photographic device making possible the acquisition of images and software adapted to the reprocessing of images.

Mean equivalent diameter is defined as the mean value of the diameter of the circumscribed circles surrounding at least 200 catalyst grains.

The mean length of the catalyst is defined as the mean value of the largest distance that is characteristic of at least 200 catalyst grains.

Below, the groups of chemical elements are provided according to the CAS classification (CRC Handbook of Chemistry and Physics, CRC Press Editor, Chief Editor D. R. Lide, 81^{st} Edition, 2000-2001). For example, group VIII according to the CAS classification corresponds to the metals of columns 8, 9, and 10 according to the new IUPAC classification; group VIB according to the CAS classification corresponds to the metals of column 6 according to the new IUPAC classification.

### DETAILED DESCRIPTION OF THE INVENTION

In accordance with the invention, the hydrotreatment method according to the invention treats a hydrocarbon feedstock that contains nitrogen and sulfur compounds with a content that is greater than 250 ppm by weight, preferably greater than 500 ppm by weight, and having a weighted mean boiling point (TMP) that is greater than 380° C.

The term ppm of sulfur (or of nitrogen) is defined for the rest of the text below as ppm by weight relative to elementary sulfur (or to elementary nitrogen), regardless of the organic molecule(s) in which the sulfur (or the nitrogen) is engaged.

The TMP is defined starting from the temperature at which 5% (T 5%), 50% (T 50%) and 70% (T 70%) of the volume of the feedstock distill according to the following formula: TMP=(T 5%+2×T 50%+4×T 70%)/7. The TMP is calculated from simulated distillation values. The TMP of the feedstock is greater than 380° C. and preferably less than 600° C., and in a more preferred manner less than 580° C. The treated hydrocarbon feedstock generally has a distillation interval of between 250° C. and 600° C., preferably between 300 and 580° C.

In the text below, we will conventionally call this feedstock “vacuum distillate,” but this designation does not have any restrictive nature. Any hydrocarbon feedstock that contains sulfur and nitrogen compounds that inhibit hydrotreatment and a TMP that is similar to that of a vacuum distillate fraction can be involved in the method that is the object of this invention. The hydrocarbon feedstock can have any chemical nature, i.e., it can have any distribution between the various chemical families, in particular paraffins, olefins, naphthenes and aromatic compounds.

Said hydrocarbon feedstock comprises organic nitrogen and/or sulfur molecules.

The organic nitrogen molecules are either basic—such as amines, anilines, pyridines, acridines, quinolines and derivatives thereof—or neutral—such as, for example, pyrroles, indoles, carbazoles and derivatives thereof.

The nitrogen content is greater than or equal to 250 ppm by weight; preferably, it is between 500 and 10,000 ppm by weight, in a more preferred manner between 700 and 4,000 ppm by weight, and in an even more preferred manner between 1,000 and 4,000 ppm by weight. The basic nitrogen content has at least one quarter of the overall nitrogen content. The basic nitrogen content is generally greater than or equal to 60 ppm by weight, in a more preferred manner between 175 and 1,000 ppm by weight, and in an even more preferred manner between 250 and 1,000 ppm by weight.

The sulfur content in the feedstock is generally between 0.01 and 5% by weight, in a preferred manner between 0.2 and 4.0% by weight, and in an even more preferred manner between 0.5 and 3.0% by weight.

Said hydrocarbon feedstock can optionally advantageously contain metals, in particular nickel and vanadium. The cumulative content of nickel and vanadium of said hydrocarbon feedstock, treated according to the hydrotreatment method according to the invention, is preferably less than 1 ppm by weight.

The asphaltene content of said hydrocarbon feedstock is generally less than 3,000 ppm by weight, in a preferred manner less than 1,000 ppm by weight, in an even more preferred manner less than 200 ppm by weight.

The treated feedstock generally contains resins; preferably, the resin content is greater than 1% by weight, in a preferred manner greater than 5% by weight. The measurement of the resin content is done according to the Standard ASTM D 2007-11.

Said hydrocarbon feedstock is advantageously selected from among the LCO or HCO (Light Cycle Oil or Heavy Cycle Oil according to English terminology (light or heavy diesel fuels obtained from a catalytic cracking unit)), the vacuum distillates, for example, diesel fuels obtained from the direct distillation of crude or from conversion units such as catalytic cracking, the coker, or the visbreaking, with the feedstocks that originate from units for extracting aromatic compounds, lubricating oil bases or that are obtained from dewaxing with solvent of lubricating oil bases, with the distillates originating from methods for desulfurization or hydroconversion in a fixed bed or in a boiling bed of atmospheric residues and/or vacuum residues and/or deasphalted oils, or else the feedstock can be a deasphalted oil or can comprise vegetable oils or even also can originate from the conversion of feedstocks obtained from the biomass. Said hydrocarbon feedstock that is treated according to the method of the invention can also be a mixture of said above-mentioned feedstocks.

Composition of the Catalysts that are Used in the Invention

In accordance with the invention, the catalysts that are used according to the invention all comprise an amorphous substrate that is selected from among alumina, silica and silica-alumina, by themselves or in a mixture, and an active phase that comprises at least one metal from group VIB, and at least one metal from group VIII. Said catalysts that are used in the n catalytic beds can, according to a preferred embodiment, optionally comprise an organic compound that contains oxygen or nitrogen and/or sulfur.

The amorphous substrate of the catalyst that is used in the invention is selected from among alumina, silica and silica-alumina, by themselves or in a mixture; i.e., it contains more than 50% alumina or silica, and in a general way, it contains only alumina, silica or silica-alumina, and optionally metals and/or dopants that are introduced during steps that are generally implemented to prepare a substrate (for example, synthesis, mixing, peptization, . . . ). The substrate is obtained after shaping (extrusion, for example) and calcination, in general between 300 and 900° C.

In a preferred case, the amorphous substrate is an alumina, and preferably an extruded alumina. Preferably, the alumina is the gamma-alumina. In a particularly preferred manner, the substrate consists of an alumina, and preferably a gamma-alumina.

In another preferred case, the amorphous substrate is a silica-alumina that contains at least 50% alumina and preferably an extruded silica-alumina. The silica content in the substrate is at most 50% by weight, most often less than or equal to 45% by weight, preferably less than or equal to 40% by weight. In a particularly preferred manner, the substrate consists of a silica-alumina, and preferably an extruded silica-alumina.

The pore volume of the amorphous substrate is preferably between 0.1 cm³/g and 1.5 cm³/g, and in a preferred manner between 0.4 cm³/g and 1.1 cm³/g. The total pore volume is measured by mercury porosimetry according to the Standard ASTM D4284-92 with a wetting angle of 140°, as described in the work by Rouquerol, F.; Rouquerol, J.; Singh, K. “Adsorption by Powders & Porous Solids: Principle, Methodology and Applications,” Academic Press, 1999, for example by means of an Autopore III™ model device of the trademark Microméritics™.

The specific surface area of the amorphous substrate is preferably between 50 m²/g and 400 m²/g, and in a preferred manner between 60 m²/g and 350 m²/g. The specific surface area is determined in this invention by the B.E.T. method, method that is described in the same work mentioned above.

Said amorphous substrate advantageously comes in the form of balls, extrudates, pellets or agglomerates that are irregular and non-spherical, whose specific shape can result from a crushing step. In a very advantageous manner, said substrate comes in the form of extrudates.

The size and the shape of the final catalyst results from the size and the shape of the amorphous substrate. In other words, the size and the shape of the amorphous substrate are equal to the size and the shape of the final catalyst.

If the catalysts come in the form of balls, the mean equivalent diameter and the mean length are equal to one another and are equal to the mean diameter of the circles that are circumscribed around catalyst balls.

If the catalysts come in the form of extrudates (cylindrical, trilobed, quadrilobed, . . . ), the mean equivalent diameter of said catalyst is defined as the mean diameter of circles that are circumscribed around catalyst extrudates according to their smaller distance, and the mean length corresponds to the mean of the characteristic greater distances or the length of the catalyst extrudates.

The equivalent diameter, i.e., the diameter of the circumscribed circle, and the length of a catalyst grain (or extrudate, for example) are measured by any technique that is known to one skilled in the art that makes possible a granulometric and morphological analysis of solids, for example, by computer processing of images that are obtained from a commercial tool of BFI-Optilas type that consists of a camera or a photographic device that makes possible the acquisition of images and software that is adapted to the reprocessing of images.

In accordance with the invention, the method uses a concatenation of n catalysts, with n being an integer of between 2 and 10, preferably between 2 and 5, in a preferred manner between 2 and 3, and in a very preferred manner with n being equal to 2. In an advantageous manner, the concatenation of n catalysts is implemented in n catalytic beds. In accordance with the invention, the mean equivalent diameters and the mean lengths of the catalysts that are used in the method according to the invention comply with the following equations:

1.1×d_{eq moy i}≤d_{eq moy i+1}≤2×d_{eq moy i}

l_{moy i}≤l_{moy i+1}≤2×l_{moy i}

d_{eq moy i}≤l_{moy i}

d_{eq moy i+1}≤l_{moy i+1}

in which:

d_{eq moy i}=mean equivalent diameter of the catalyst in the i^{th} position in the concatenation of n catalysts

d_{eq moy i+1}=mean equivalent diameter of the catalyst in the i+1^{th} position in the concatenation of n catalysts

l_{moy i}=mean length of the catalyst in the i^{th} position in the concatenation of n catalysts

l_{moy i+1}=mean length of the catalyst in the i+1^{th} position in the concatenation of n catalysts

with i being a whole number between 1 and n−1

Preferably, the mean equivalent diameters and the mean lengths of the catalysts that are used in the method according to the invention comply with the following equations:

1.1×d_{eq moy i}≤d_{eq moy i+1}≤1.8×d_{eq moy i}

l_{moy i}≤l_{moy i+1}≤1.8×l_{moy i}

d_{eq moy i}≤l_{moy i}

d_{eq moy i+1}≤l_{moy i+1}

with d_{eq moy i}, d_{eq moy i+1}, l_{moy i}, l_{moy i+1} having the above-mentioned definition.

According to a very preferred embodiment in which n=2, i.e., in the case where a concatenation of 2 catalysts is implemented in the method according to the invention, the mean equivalent diameters and the mean lengths of the catalysts that are used in the method according to the invention comply with the following equations:

1.1×d_{eq moy 1}≤d_{eq moy 2}≤2×d_{eq moy 1}

preferably 1.1×d_{eq moy 1}≤d_{eq moy 2}≤1.8×d_{eq moy 1}

l_{moy 1}≤l_{moy 2}≤2×l_{moy 1}

preferably l_{moy 1}≤l_{moy 2}≤1.8×l_{moy 1}

d_{eq moy 1}≤l_{moy 1}

d_{eq moy 2}≤l_{moy 2}

where:

d_{eq moy 1}=mean equivalent diameter of the catalyst in the 1^{st} position in the concatenation of 2 catalysts

d_{eq moy 2}=mean equivalent diameter of the catalyst in the 2^{nd} position in the concatenation of 2 catalysts

l_{moy 1}=mean length of the catalyst in the 1^{st} position in the concatenation of 2 catalysts

l_{moy 2}=mean length of the catalyst in the 2^{nd} position in the concatenation of 2 catalysts

In this case, the substrate of the catalyst and the catalyst that is used in the 1^{st} position in the concatenation of 2 catalysts have a mean equivalent diameter (d_{eq moy 1}) that is less than the mean equivalent diameter of the catalyst that is used in the 2^{nd} position in the concatenation of 2 catalysts (d_{eq moy 2}), and they have a mean length (l_{moy 1}) that is less than or equal to the mean length of the catalyst that is used in the 2^{nd} position (l_{moy 2}) of the concatenation.

According to the invention, the catalysts that are used in the method according to the invention all contain one or more elements from group VIB and group VIII, optionally phosphorus and/or dopants that are selected from among boron and/or fluorine, as well as optionally one or more organic molecules.

The metal from group VIB that is present in the active phase of the catalyst that is used in the hydrotreatment method according to the invention is preferably selected from among molybdenum, tungsten, and the mixture of these two elements, and very preferably, the metal from group VIB is molybdenum.

The metal from group VIII that is present in the active phase of the catalyst that is used in the hydrotreatment method according to the invention is preferably selected from among cobalt, nickel, and the mixture of these two elements.

Preferably, the active phase of the catalyst that is used in the concatenation of the method according to the invention is selected from the group that is formed by the combination of the following elements: cobalt-molybdenum, nickel-molybdenum, cobalt-nickel-molybdenum, cobalt-tungsten, nickel-tungsten, cobalt-molybdenum-tungsten, or nickel-molybdenum-tungsten. In a very preferred manner, the active phase of the catalyst that is used is the combination of the following elements: cobalt-molybdenum, nickel-molybdenum, or cobalt-nickel-molybdenum.

The content in metal from group VIB is between 5 and 40% by weight, preferably between 8 and 35% by weight, and in a more preferred manner between 10 and 30% by weight of metal oxide from group VIB in relation to the total mass of the catalyst.

The content of the catalyst in metal from group VIII is between 1 and 10% by weight, preferably between 1.5 and 9% by weight, and in a more preferred manner between 2 and 8% by weight of metal oxide from group VIII in relation to the total mass of the catalyst.

The molar ratio of metal from group VIII to metal from group VIB of the catalyst according to the invention in the oxide form thereof is preferably between 0.1 and 0.8, preferably between 0.15 and 0.6, and in an even more preferred manner between 0.2 and 0.5.

The catalysts that are used in the specific concatenation according to the invention can also comprise phosphorus as dopant and/or dopants selected from among boron and fluorine, by themselves or in a mixture. The dopant is an added element that in itself does not have any catalytic nature but that increases the catalytic activity of the active phase.

When the catalyst comprises a phosphorus dopant, the phosphorus content in said catalyst that is used in the concatenation is preferably between 0.1 and 10% by weight of P₂O₅, preferably between 0.2 and 8% by weight of P₂O₅, in a very preferred manner between 0.3 and 8% by weight of P₂O₅ in relation to the total mass of the catalyst.

In this case, the molar ratio of phosphorus to metal from group VIB in the catalyst that is used in the concatenation is greater than or equal to 0.05, preferably greater than or equal to 0.07, in a more preferred manner between 0.08 and 0.5.

The catalysts that are used according to the invention can advantageously also contain at least one dopant that is selected from among boron and fluorine and a mixture of boron and fluorine.

When the hydrotreatment catalysts contain boron as dopant, the boron content in said catalyst in oxide form is preferably between 0.1 and 10% by weight of boron oxide, preferably between 0.2 and 7% by weight of boron oxide, in a very preferred manner between 0.2 and 5% by weight of boron oxide in relation to the total mass of the catalyst.

When the hydrotreatment catalysts contain fluorine as dopant, the fluorine content in said catalyst in oxide form that is obtained is preferably between 0.1 and 10% by weight of fluorine, preferably between 0.2 and 7% by weight of fluorine, in a very preferred manner between 0.2 and 5% by weight of fluorine in relation to the total mass of the catalyst.

According to a preferred embodiment, the n catalysts that are used in the concatenation according to the invention are additive catalysts and comprise at least one organic compound that contains oxygen or nitrogen and/or sulfur.

The organic compound that contains sulfur can be one or more compounds that are selected from among the compounds that comprise one or more chemical groups that are selected from among a thiol, thioether, sulfone or sulfoxide group. By way of example, the organic compound that contains sulfur can be one or more compounds that are selected from the group that consists of thioglycolic acid, 2-hydroxy-4-methylthiobutanoic acid, a sulfonated derivative of a benzothiophene, or a sulfoxide derivative of a benzothiophene.

The organic compound that contains oxygen can be one or more compounds that are selected from among a carboxylic acid, an alcohol, an aldehyde, or an ester. By way of example, the organic compound that contains oxygen can be one or more compounds that are selected from the group that consists of ethylene glycol, glycerol, polyethylene glycol (with a molecular weight of 200 to 1,500), acetophenone, 2,4-pentanedione, pentanol, acetic acid, maleic acid, oxalic acid, tartaric acid, formic acid, citric acid, and C1-C4 dialkyl succinate. The dialkyl succinate that is used is preferably selected from the group that consists of dimethyl succinate, diethyl succinate, dipropyl succinate, and dibutyl succinate. In a preferred manner, the C1-C4 dialkyl succinate that is used is dimethyl succinate or diethyl succinate. In a very preferred manner, the C1-C4 dialkyl succinate that is used is dimethyl succinate. At least one C1-C4 dialkyl succinate is used, preferably only one, and preferably dimethyl succinate.

The organic compound that contains nitrogen can be selected from among one amine. By way of example, the organic compound that contains nitrogen can be ethylenediamine or tetramethylurea.

The organic compound that contains oxygen and nitrogen can be selected from among an amino carboxylic acid, an amino alcohol, a nitrile, or an amide. By way of example, the organic compound that contains oxygen and nitrogen can be aminotriacetic acid, 1,2-cyclohexanediaminetetraacetic acid, monoethanolamine, acetonitrile, N-methylpyrrolidone, dimethylformamide, or else EDTA.

Preferably, the organic compound contains oxygen.

In a variant, the catalyst that is used in the method of the invention contains C1-C4 dialkyl succinate (and, in particular, dimethyl succinate) and/or acetic acid and/or citric acid.

In a variant, the catalyst that is used in the method of the invention contains at least γ-ketovaleric acid, 4-hydroxyvaleric acid, 2-pentenoic acid, 3-pentenoic acid, or 4-pentenoic acid.

When an organic compound that contains nitrogen and/or oxygen and/or sulfur is used for the preparation of catalysts that are used in the concatenation of the method of the invention, the molar ratio of organic compound(s) that contain(s) oxygen and/or nitrogen and/or sulfur by element(s) of group VIB on the catalyst is between 0.05 to 5 mol/mol, preferably between 0.1 to 4 mol/mol, in a preferred manner between 0.2 and 3 mol/mol, calculated on the basis of said corresponding compounds that are introduced into the impregnation solution(s).

The n catalysts that are used in the concatenation according to the invention can have a catalytic composition (in terms of contents and nature of the metals, presence, nature and content of additive and/or dopant) and a pore distribution that are identical or different. In the case where they have a catalytic composition and a pore distribution that are identical, said n catalysts differ only by the relationships between the mean equivalent diameters and the mean lengths, as claimed.

Preparation of the Catalysts that are Used in the Invention

Catalysts that are used according to the invention can be prepared by any method that is known to one skilled in the art.

In particular, catalyst substrates that are used according to the invention are shaped according to all of the techniques that are known to one skilled in the art and preferably according to the techniques that are selected from among extrusion, pelletizing, shaping in the form of balls with a rotating bezel or with a drum, drop coagulation, “oil-drop,” “oil-up,” and tableting. Preferably, the shaping is carried out by extrusion.

The thus obtained substrates are shaped in the form of grains of different shapes and sizes. Said substrates and the corresponding catalysts are used preferably in the form of extrudates that are cylindrical or multilobed, such as bilobed, trilobed, multilobed of straight or twisted shape, but can optionally be manufactured and used in the form of tablets, pellets, grains, rings, balls, wheels.

If the catalyst that is used in the concatenation of the method according to the invention comprises an organic compound that contains oxygen and/or nitrogen and/or sulfur, these catalysts are only dried at a temperature that is less than 200° C. and are considered to be “additive catalysts.” These additive catalysts do not undergo calcination during their preparation, i.e., they do not undergo the heat treatment step at a temperature that is greater than 200° C.; their active phase then comprises the metals from groups VIB and VIII that are not transformed in oxide form. If the steps for preparation of the catalysts that are used according to the method of the invention comprise bringing an organic compound that contains oxygen and/or nitrogen and/or sulfur into contact with metals, several implementations are possible in particular according to the method for introducing the organic compound that contains oxygen and/or nitrogen and/or sulfur, which can be carried out either at the same time as the impregnation of metals (co-impregnation), or after the impregnation of metals (post-impregnation), or finally before the impregnation of metals (pre-impregnation). In addition, the contact step can combine at least two implementations, for example the co-impregnation and the post-impregnation. Each method, by itself or in combination, can take place in one or more steps. It is important to emphasize that the catalyst according to the invention during its preparation method does not undergo heat treatment at a temperature that is higher than 200° C. or calcination if the latter contains an organic compound that contains oxygen and/or nitrogen and/or sulfur, so as to preserve at least in part this organic compound in the catalyst. Here, calcination is defined as a heat treatment in a gas that contains air or oxygen at a temperature that is higher than or equal to 200° C. However, the catalyst precursor can undergo a calcination step before the organic compound that contains oxygen and/or nitrogen and/or sulfur is introduced, in particular after the step for impregnation of elements from groups VIB and VIII and optionally phosphorus and/or another dopant that would be followed by a post-impregnation of at least one organic additive or after a regeneration of a catalyst that is already used that would also be followed by a post-impregnation of at least one organic additive. The hydrogenating group that comprises the elements from group VIB and group VIII of the catalyst according to the invention, also called active phase, then is not found in an oxide form.

Although the catalysts that are used in the concatenation of the method according to the invention do not comprise an organic compound that contains oxygen and/or nitrogen and/or sulfur, the latter have then only been dried at a temperature that is lower than 200° C. and are then considered to be “dried catalysts,” or catalysts that are dried at a temperature that is lower than 200° C. and then calcined at a temperature that is higher than 200° C. and are then considered to be “calcined catalysts.” These last calcined catalysts are the only ones to have an active phase that comprises the metals from groups VIB and VIII in oxide form.

Regardless of the implementation, the preparation of catalysts generally comprises at least one impregnation step, preferably a dry impregnation step or an excess solution impregnation, in which the substrate is impregnated by an impregnation solution that comprises at least one element from group VIB, at least one element from group VIII, optionally phosphorus and optionally a dopant such as boron or fluorine. In the event of co-impregnation, this impregnation solution also comprises at least one organic compound that contains oxygen and/or nitrogen and/or sulfur. The elements from group VIB and group VIII are generally introduced by impregnation, preferably by dry impregnation or by excess solution impregnation. Preferably, all of the elements from group VIB and group VIII are introduced by impregnation, preferably by dry impregnation, and this regardless of the implementation.

The metals from group VIB and group VIII of said catalyst can advantageously be introduced into the catalyst at various levels of the preparation and in various ways. Said metals from group VIB and group VIII can advantageously be introduced in part during the shaping of said amorphous substrate or preferably after this shaping.

In the case where the metals from group VIB and group VIII are introduced in part during the shaping of said amorphous substrate, they can be introduced in part only at the time of mixing with an alumina gel or silica gel or silica-alumina gel selected as a matrix, with the rest of the metals then being introduced subsequently. In a preferred manner, when the metals from group VIB and group VIII are introduced in part at the time of mixing, the proportion of the metal from group VIB that is introduced during this step is less than or equal to 20% of the total amount of metal from group VIB that is introduced onto the final catalyst, and the proportion of the metal from group VIII that is introduced during this step is less than or equal to 50% by weight of the total amount of metal from group VIII that is introduced onto the final catalyst. In the case where the metals from group VIB and group VIII are introduced at least in part and preferably entirely, after the shaping of said amorphous substrate, the introduction of the metals from group VIB and group VIII onto the amorphous substrate can advantageously be carried out by one or more excess solution impregnations onto the amorphous substrate, or preferably by one or more dry impregnations, and in a preferred manner by a single dry impregnation of said amorphous substrate, using aqueous or organic solutions that contain precursors of the metals. Dry impregnation consists in bringing the substrate into contact with a solution that contains at least one precursor of said metal (metals) of group VIB and/or group VIII, whose volume is equal to the pore volume of the substrate that is to be impregnated. The solvent of the impregnation solution can be water or an organic compound such as an alcohol. Preferably, an aqueous solution is used as an impregnation solution.

In a very preferred manner, the metals from group VIB and group VIII are introduced in their entirety after the shaping of said amorphous substrate by dry impregnation of said substrate using an aqueous impregnation solution that contains the precursor salts of the metals. The introduction of the metals from group VIB and group VIII can also advantageously be carried out by one or more impregnations of the amorphous substrate, by a solution that contains the precursor salts of the metals. In the case where the metals are introduced in several impregnations of the corresponding precursor salts, an intermediate drying step of the catalyst is in general carried out at a temperature of between 50 and 180° C., in a preferred manner between 60 and 150° C., and in a very preferred manner between 75 and 130° C.

In a preferred manner, the metal from group VIB is introduced at the same time as the metal from group VIII, regardless of the introduction method.

The molybdenum precursors that can be used are well known to one skilled in the art. For example, among the molybdenum sources, it is possible to use oxides and hydroxides, molybdic acids and their salts, in particular ammonium salts, such as ammonium molybdate, ammonium heptamolybdate, phosphomolybdic acid (H₃PMo₁₂O₄₀) and their salts, and optionally silicomolybdic acid (H₄SiMo₁₂O₄₀) and its salts. The molybdenum sources can also be heteropoly compounds of the following types: Keggin, lacunary Keggin, substituted Keggin, Dawson, Anderson, Strandberg, for example. Molybdenum trioxide and the heteropolyanions of the Strandberg, Keggin, lacunary Keggin, or substituted Keggin type are preferably used.

The tungsten precursors that can be used are also well known to one skilled in the art. For example, among the tungsten sources, it is possible to use oxides and hydroxides, tungstic acids and their salts, in particular the ammonium salts, such as ammonium tungstate, ammonium metatungstate, phosphotungstic acid and their salts, and optionally silicotungstic acid (H₄SiW₁₂O₄₀) and its salts. The tungsten sources can also be heteropoly compounds of the following types: Keggin, lacunary Keggin, substituted Keggin, Dawson, for example. Oxides and ammonium salts, such as ammonium metatungstate or heteropolyanions of the Keggin, lacunary Keggin, or substituted Keggin type, are preferably used.

The precursors of the elements of group VIII that can be used are advantageously selected from among oxides, hydroxides, hydroxycarbonates, carbonates, and nitrates of the elements from group VIII; for example, nickel hydroxycarbonate, cobalt carbonate or cobalt hydroxide are used in a preferred manner.

Phosphorus can be introduced in its entirety or in part by impregnation. Preferably, it is introduced by impregnation, preferably dry impregnation, using a solution that contains the precursors of the elements from group VIB and group VIII.

Said phosphorus can advantageously be introduced by itself or in a mixture with at least one of the elements from group VIB and group VIII during any of the impregnation steps of the hydrogenating function if the latter is introduced several times. Some or all of said phosphorus can also be introduced during the impregnation of the organic compound that contains nitrogen and/or oxygen and/or sulfur. It can also be introduced upon synthesis of the substrate, at any step of the synthesis of the latter. It can thus be introduced before, during or after the mixing of the alumina gel matrix that is selected, such as, for example and preferably, the aluminum oxyhydroxide (boehmite) precursor of alumina.

The preferred phosphorus precursor is orthophosphoric acid H₃PO₄, but its salts and esters, such as the ammonium phosphates, are also suitable. Phosphorus can also be introduced at the same time as the element(s) from group VIB in the form of heteropolyanions of the Keggin, lacunary Keggin, substituted Keggin or Strandberg type.

Any impregnation solution that is described in this invention can comprise any polar solvent that is known to one skilled in the art. Said polar solvent that is used is advantageously selected from the group formed by methanol, ethanol, water, phenol, cyclohexanol, by themselves or in a mixture. Said polar solvent can also advantageously be selected from the group that is formed by propylene carbonate, DMSO (dimethyl sulfoxide), N-methylpyrrolidone (NMP) or sulfolane, by itself or in a mixture. In a preferred manner, a polar protic solvent is used. A list of common polar solvents as well as their dielectric constant can be found in the book “Solvents and Solvent Effects in Organic Chemistry,” C. Reichardt, Wiley-VCH, 3^{rd} Edition, 2003, pages 472-474. In a very preferred manner, the solvent that is used is water or ethanol, and in a particularly preferred manner, the solvent is water. In a possible embodiment, solvent can be absent in the impregnation solution.

When the catalyst also comprises a dopant that is selected from among boron, fluorine or a mixture of boron and fluorine, the introduction of this (these) dopant(s) can be done in the same manner as the introduction of phosphorus in various steps of the preparation and in various manners. Said dopant can advantageously be introduced by itself or in a mixture with at least one of the elements from group VIB and group VIII during any of the impregnation steps of the hydrogenating function if the latter is introduced several times. Some or all of said dopant can also be introduced during the impregnation of the organic compound that contains nitrogen and/or oxygen and/or sulfur. It can also be introduced upon the synthesis of the substrate, at any step of the synthesis of the latter. It can thus be introduced before, during or after the mixing of the selected alumina gel matrix, such as, for example and preferably, the aluminum oxyhydroxide (boehmite) precursor of alumina.

Said dopant, when there is one of them, is advantageously introduced in a mixture with the precursor(s) of the elements from group VIB and group VIII, in its entirety or in part on the substrate that is shaped by dry impregnation of said substrate using a solution, preferably aqueous, containing the precursors of metals, the precursor of phosphorus, and the precursor(s) of the dopant(s) (and also containing an organic compound that contains nitrogen and/or oxygen and/or sulfur in the co-impregnation method).

The boron precursors can be boric acid, orthoboric acid H₃BO₃, ammonium biborate or ammonium pentaborate, boron oxide, boric esters. Boron can be introduced by, for example, a solution of boric acid in a water/alcohol mixture or else in a water/ethanolamine mixture. Preferably, the boron precursor, if boron is introduced, is orthoboric acid.

The fluorine precursors that can be used are well known to one skilled in the art. For example, the fluoride anions can be introduced in the form of hydrofluoric acid or its salts. These salts are formed with alkaline metals, ammonium or an organic compound. In this latter case, the salt is advantageously formed in the reaction mixture by reaction between the organic compound and hydrofluoric acid. The fluorine can be introduced by, for example, impregnation of an aqueous solution of hydrofluoric acid, or ammonium fluoride, or else ammonium bifluoride.

When the catalyst that is used according to the method of the invention comprises at least one organic compound that contains oxygen and/or nitrogen and/or sulfur, this organic additive is advantageously introduced into an impregnation solution that, according to the preparation method, can be the same solution or a solution that is different from the one that contains the elements from groups VIB and VIII. The introduction of the organic compound that contains oxygen and/or nitrogen and/or sulfur can be carried out at the same time as the impregnation of metals; co-impregnation or then post-impregnation is then mentioned if the impregnation is carried out after the introduction of metals, or finally pre-impregnation if the impregnation is carried out before the impregnation of metals.

According to an alternative embodiment, the introduction of the organic compound can be done by combining at least two of the above-mentioned impregnation methods (co-impregnation, post-impregnation, pre-impregnation), for example, the co-impregnation of an organic compound that contains oxygen and/or nitrogen and/or sulfur, and the post-impregnation of an organic compound that contains oxygen and/or nitrogen and/or sulfur that can be identical or different from the one that is used for co-impregnation.

Advantageously, after each impregnation step, the impregnated substrate is allowed to mature. Maturation makes it possible for the impregnation solution to be dispersed in a homogeneous manner within the substrate.

Any maturation step that is described in this invention is advantageously carried out at atmospheric pressure, in a water-saturated atmosphere and at a temperature of between 17° C. and 50° C., and preferably at ambient temperature. Generally, a maturation period of between 10 minutes and 48 hours, and preferably between 30 minutes and 5 hours, is sufficient. Longer periods are not ruled out, but they are not necessarily an improvement.

The catalyst precursor that is obtained following the impregnation step or steps, an optionally matured precursor, is advantageously subjected to:
a step for drying at a temperature that is lower than 200° C. without a subsequent calcination step,
or a step for drying at a temperature that is lower than 200° C. followed by a calcination step at a temperature of between 200 and 900° C.

Any drying step that is described in this invention is carried out at a temperature that is lower than 200° C., preferably between 50 and 180° C., in a preferred manner between 70 and 150° C., and in a very preferred manner between 75 and 130° C.

The drying step is advantageously carried out by any technique that is known to one skilled in the art. It is advantageously carried out at atmospheric pressure or at reduced pressure.

In a preferred manner, this step is carried out at atmospheric pressure. It is advantageously carried out in a flushed bed by using air or any other hot gas. In a preferred manner, when the drying is carried out in a fixed bed, the gas that is used is either air or an inert gas such as argon or nitrogen. In a very preferred manner, the drying is carried out in a bed that is flushed in the presence of nitrogen and/or air. Preferably, the drying step has a short duration of between 5 minutes and 8 hours, preferably between 30 minutes and 4 hours, and in a very preferred manner between 1 hour and 3 hours. When an organic compound that contains oxygen and/or nitrogen and/or sulfur makes up the catalyst, the drying step is carried out in such a way as to preserve preferably at least 30%, preferably at least 50%, and in a very preferred manner at least 70% of the amount that is introduced calculated on the basis of the carbon remaining on the catalyst. At the end of the drying step, a dried catalyst that is then optionally calcined is obtained.

Any optional calcination step that is described in this invention is carried out at a temperature that is higher than 200° C., preferably between 200 and 900° C., in a preferred manner between 250 and 700° C., and in a very preferred manner between 350 and 550° C.

The calcination step is advantageously carried out by any technique that is known to one skilled in the art. It is advantageously carried out at atmospheric pressure or at reduced pressure. In a preferred manner, this step is carried out at atmospheric pressure. It is advantageously carried out in a flushed bed by using air or any other hot gas. In a preferred manner, when the calcination is carried out in a fixed bed, the gas that is used is either air or an inert gas such as argon or nitrogen. In a very preferred manner, calcination is carried out in a bed that is flushed in the presence of nitrogen and/or air. Preferably, the calcination step has a short duration of between 5 minutes and 8 hours, preferably between 30 minutes and 4 hours, and in a very preferred manner between 1 hour and 3 hours. Generally, only the catalyst precursors that do not contain an organic additive that contains nitrogen and/or oxygen and/or sulfur are calcined.

### Use of the Catalyst

The method according to the invention can be implemented in one or m reactors, with m being a whole number between 2 and n, n being the number of catalysts that are used in the concatenation according to the invention, and having the above-mentioned definition. It is generally carried out in a fixed bed. The n catalysts of the concatenation according to the invention are distributed in said m reactor(s). Regardless of the number of reactors, the total number of catalysts is always n.

When the method according to the invention is implemented in m reactors, the first reactor advantageously comprises a first catalyst in the first catalytic bed i of the first reactor that has a reduced mean equivalent diameter and a mean length that is reduced or equal in relation to the mean equivalent diameter and to the mean length of a catalyst that is used in the following catalytic bed i+1, and so on to the last catalytic bed that uses the last catalyst of the last reactor.

Optionally, the effluent that exits from a p^{th} reactor, with p being a whole number of between 1 and m−1, can be subjected to a separation step that makes it possible to separate a light fraction—that contains in particular H₂S and NH₃ that are formed during the hydrotreatment that takes place in said p^{th} reactor—from a heavy fraction that contains unconverted hydrocarbons. The heavy fraction that is obtained after the separation step is then introduced into the p+1^{th} reactor of the method according to the invention. The separation step can be carried out by distillation, flash separation or any other method that is known by one skilled in the art.

When the method according to the invention is implemented in a single reactor, said reactor comprises a concatenation of n catalysts and comprises, in accordance with the invention, a first catalyst in the first catalytic bed i that has a reduced mean equivalent diameter and a mean length that is reduced or equal in relation to the mean equivalent diameter and to the mean length of a catalyst that is used in the following catalytic bed i+1 and so on to the last catalytic bed that uses the last catalyst in said reactor.

In the case where the number of reactor(s) is equal to 1 or 2 and in the preferred embodiment in which said method implements a concatenation of two catalysts (n=2), the first catalytic bed that contains the first catalyst occupies a volume V1, and the second catalytic bed that contains the second catalyst occupies a volume V2, with the distribution of the volumes V1/V2 being between 10% by volume/90% by volume and 90% by volume/10% by volume respectively of said first and second catalytic beds.

The operating conditions that are used in the hydrotreatment method according to the invention are advantageously as follows: the temperature is advantageously between 200 and 450° C., and preferably between 300 and 410° C.; the pressure is advantageously between 0.5 and 30 MPa, and preferably between 4 and 20 MPa; the hourly volumetric flow rate of the feedstock in relation to the volume of each catalyst (VVH) is advantageously between 0.2 and 20 h⁻¹ and preferably between 0.5 and 10 h⁻¹; and the hydrogen/feedstock ratio that is expressed in terms of normal cubic meters (Nm³) of hydrogen per cubic meter (m³) of hydrocarbon feedstock is advantageously between 50 Nm³/m³ to 2,000 Nm³/m³.

When the method according to the invention is implemented in m reactors, the operating conditions can be identical or different in the m reactors.

The hydrotreatment method according to the invention is particularly adapted for the hydrotreatment of feedstocks that comprise high contents of sulfur and organic nitrogen, such as the vacuum distillate or feedstocks that are obtained from catalytic cracking, the coker or visbreaking.

The method according to this invention makes it possible to produce a hydrocarbon fraction that is hydrotreated, i.e., from which a large portion of possible sulfur and nitrogen compounds are removed at the same time. The sulfur compound contents in the effluents after the hydrotreatment are generally less than or equal to 1,200 ppm by weight of sulfur, preferably less than 1,000 ppm by weight, in a very preferred manner less than 800 ppm by weight. Preferably, according to the method according to the invention, the conversion of sulfur products is higher than 90%, and preferably higher than 95%. Preferably, according to the method according to the invention, the hydrodenitration conversion is greater than 85%, preferably greater than 90%.

Sulfurization of the Catalysts

Before its use for the reaction of hydrotreatment and/or hydrocracking, it is advantageous to transform the dried and/or calcined and/or additive catalyst that is obtained according to any one of the introduction methods described in this invention into a sulfide catalyst so as to form its active type. This step of activation or sulfurization is carried out by methods that are well known to one skilled in the art and advantageously under a sulfo-reducing atmosphere in the presence of hydrogen and hydrogen sulfide.

Said catalyst that is used in the method according to the invention is advantageously sulfurized in an ex-situ or in-situ manner. The sulfurizing agents are the H₂S gas or any other compound that contains the sulfur that is used for the activation of hydrocarbon feedstocks for the purpose of sulfurizing the catalyst. Said compounds that contain sulfur are advantageously selected from among the alkyl disulfides, such as, for example, dimethyl disulfide (DMDS), alkyl sulfides, such as, for example, dimethyl sulfide, thiols, such as, for example, n-butyl mercaptan (or 1-butanethiol), polysulfide compounds of the tert-nonyl polysulfide type, or any other compound that is known to one skilled in the art that makes it possible to obtain a good sulfurization of the catalyst. In a preferred manner, the catalyst is sulfurized in situ in the presence of a sulfur-containing hydrocarbon feedstock or in the presence of a sulfurizing agent and a hydrocarbon feedstock. In a very preferred manner, the catalyst is sulfurized in situ in the presence of an additive hydrocarbon feedstock of dimethyl disulfide.

Application of the Method According to the Invention in an FCC Method

According to a first variant, the hydrotreatment method according to the invention is advantageously implemented as pretreatment in a fluidized-bed catalytic cracking method (or FCC method for Fluid Catalytic Cracking according to English terminology). The FCC method can be executed in a conventional manner that is known to one skilled in the art under suitable cracking conditions for the purpose of producing hydrocarbon products of lower molecular weight. For example, a summary description of catalytic cracking (whose first industrial implementation dates back to 1936 (HOUDRY method) or to 1942 for the use of a fluidized-bed catalyst) will be found in ULLMANS ENCYCLOPEDIA OF INDUSTRIAL CHEMISTRY, VOLUME A 18, 1991, pages 61 to 64.

A conventional catalyst that comprises a matrix, optionally an additive and at least one zeolite, is usually used. The amount of zeolite is variable but usually from about 3 to 60% by weight, often from approximately 6 to 50% by weight, and most often from approximately 10 to 45% by weight. The zeolite is usually dispersed in the matrix. The amount of additive is usually from approximately 0 to 30% by weight and often from approximately 0 to 20% by weight. The amount of matrix represents the make-up to 100% by weight. The additive is generally selected from the group that is formed by the oxides of metals from group IIA of the periodic table, such as, for example, magnesium oxide or calcium oxide, the oxides of rare earths, and the titanates of metals from group IIA. The matrix is most often a silica, an alumina, a silica-alumina, a silica-magnesia, a clay or a mixture of two or more of these products. The most commonly used zeolite is the Y zeolite.

Cracking in an essentially vertical reactor is carried out either in upward mode (riser) or in downward mode (dropper). The selection of the catalyst and operating conditions are functions of the products that are desired based on the treated feedstock, as is described in, for example, the article by M. MARCILLY, pages 990-991 published in the review by the French Petroleum Institute of November-December 1975, pages 969-1006. The procedure is usually performed at a temperature from approximately 450 to approximately 600° C. and dwell times within the reactor that are less than 1 minute, often from approximately 0.1 to approximately 50 seconds.

The pretreatment also makes it possible to limit the content of organic nitrogen at the end of the pretreatment step so as to protect the zeolite-based catalytic cracking catalyst that is very sensitive to organic nitrogen.

Thus, the invention also relates to a fluidized-bed catalytic cracking method that implements the hydrotreatment method according to the invention, in which said hydrotreated effluent is brought into contact—under the operating conditions of catalytic cracking—with at least one catalytic cracking catalyst in such a way as to obtain a cracked effluent.

Application of the Method According to the Invention in a Hydrocracking Method

According to a second variant, the hydrotreatment method according to the invention is advantageously implemented as pretreatment in a hydrocracking method, and more particularly in a hydrocracking method said to be in “one step” or in a hydrocracking method said to be in “two steps.” The hydrocracking method makes it possible to convert petroleum fractions, in particular vacuum distillates (DSV), into lighter and more upgradable products (gasoline, middle distillates).

A hydrocracking method said to be in “one step” comprises—in the first place and in a general way—an advanced hydrotreatment that has as its object to carry out advanced hydro-denitrification and desulfurization of the feedstock before it is sent to the hydrocracking catalyst(s). Said one-step hydrocracking method is particularly advantageous when said hydrocracking catalyst(s) comprise(s) a substrate that comprises zeolite crystals. This advanced hydrotreatment of the feedstock brings about only a limited conversion of the feedstock into lighter fractions, which remains inadequate and should therefore be completed on the more active hydrocracking catalyst(s). However, it should be noted that no separation of the effluents takes place between the various catalytic beds: the entire effluent exiting from the catalytic hydrotreatment bed is injected into the catalytic bed(s) that contain(s) said hydrocracking catalyst(s), and then a separation of the products that are formed is carried out. This version of the hydrocracking has a variant that offers a recycling of the unconverted fraction to at least one of the hydrocracking catalytic beds for the purpose of a more advanced conversion of the feedstock. Advantageously, the hydrotreatment method according to the invention that comprises the specific concatenation according to the invention is implemented upstream from a hydrocracking catalyst in a one-step hydrocracking method. It also makes it possible to limit the content of organic nitrogen at the end of the pretreatment step so as to protect the zeolite-based hydrocracking catalyst that is very sensitive to organic nitrogen.

A so-called “two-step” hydrocracking method comprises a first step that has as its objective, as in the “one-step” method, to carry out the hydrotreatment of the feedstock, but also to achieve a conversion of the latter on the order of, in general, from 40 to 60%. The effluent that is obtained from the first step then undergoes a separation, generally by distillation, most often called intermediate separation, which has as its objective to separate the conversion products from the unconverted fraction. In the second step of the two-step hydrocracking method according to the invention, only the fraction of the feedstock that is not converted during the first step is treated. This separation makes it possible for the two-step hydrocracking method according to the invention to be more selective in middle distillate (kerosene+diesel) than the one-step method according to the invention. Actually, the intermediate separation of the conversion products prevents their “over-cracking” into naphtha and gas in the second step in the hydrocracking catalyst(s). Furthermore, it should be noted that the unconverted fraction of the feedstock that is treated in the second step in general contains very low contents of NH₃ as well as of organic nitrogen compounds, in general less than 20 ppm by weight, and even less than 10 ppm by weight.

Said first step is implemented in the presence of the specific concatenation of catalysts according to the invention and a hydrocracking catalyst so as to carry out hydrotreatment and conversion on the order of in general 40 to 60%. The catalytic beds of the specific concatenation of catalysts according to the invention are advantageously upstream from the hydrocracking catalyst. Said second step is generally implemented in the presence of a hydrocracking catalyst with a composition that is different from the one that is present for the implementation of said first step.

The hydrocracking methods are generally carried out at a temperature of between 250 and 480° C., advantageously between 320 and 450° C., preferably between 330 and 435° C., under a pressure of between 2 and 25 MPa, and in a preferred manner between 3 and 20 MPa; the hourly volumetric flow rate of the feedstock in relation to the volume of each catalyst (VVH) is advantageously between 0.1 and 40 h⁻¹, preferably between 0.2 and 12 h⁻¹, in a very preferred manner between 0.4 and 6 h⁻¹; and the hydrogen/feedstock ratio that is expressed in terms of normal cubic meters (Nm³) of hydrogen per cubic meter (m³) of hydrogen feedstock is advantageously between 80 NL/L to 5,000 NL/L, preferably between 100 and 2,000 NL/L.

The hydrocracking catalysts are of the bifunctional type: they combine an acid function with a hydro-dehydrogenating function. The acid function is provided by porous substrates whose surface areas vary generally from 150 to 800 m²·g⁻¹ and that have a surface acidity, such as halogenated (chlorinated or fluorinated in particular) aluminas, boron oxide and aluminum oxide combinations, amorphous or crystallized mesoporous aluminosilicates, and the zeolites that are dispersed in an oxide binder. The hydro-dehydrogenating function is provided by the presence of an active phase based on at least one metal from group VIB and optionally at least one metal from group VIII of the periodic table. The most common formulations are of the nickel-molybdenum (NiMo) type and nickel-tungsten (NiW) type, and more rarely of the cobalt-molybdenum (CoMo) type. After preparation, the hydro-dehydrogenating function often comes in oxide form. The usual methods leading to the formation of the hydro-dehydrogenating phase of the hydrocracking catalysts consist in a deposition of molecular precursor(s) of at least one metal from group VIB and optionally at least one metal from group VIII onto an acid oxide substrate by the so-called “dry impregnation” technique followed by steps of maturation, drying and calcination leading to the formation of the oxide form of said metal(s) that are used. The active and stable form for the hydrocracking methods being the sulfurized form, these catalysts are to undergo a sulfurization step. The latter can be carried out in the unit of the associated method (in-situ sulfurization is then mentioned) or prior to the loading of the catalyst into the unit (ex-situ sulfurization is then mentioned).

Thus, the invention also relates to a hydrocracking method that implements the hydrotreatment method according to the invention, in which—in the presence of hydrogen and under the hydrocracking operating conditions—said hydrotreated effluent is brought into contact with at least one hydrocracking catalyst in such a way as to obtain a hydrocracked effluent.

The following examples make it possible to illustrate the advantages of the invention without, however, limiting the scope thereof.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing and in the examples, all temperatures are set forth uncorrected in degrees Celsius and, all parts and percentages are by weight, unless otherwise indicated.

The entire disclosures of all applications, patents and publications, cited herein and of corresponding French application No. 17/62.463, filed Dec. 19, 2017, are incorporated by reference herein.

### EXAMPLES

### Example 1—Preparation of Catalysts

The catalysts have been prepared by dry impregnation of four aluminum substrates by an aqueous solution that contains the precursors of molybdenum, cobalt, phosphorus, and citric acid playing the role of organic additive. The four substrates are in the form of trilobed extrudates with a mean length of 3 mm and mean equivalent diameters respectively of 1.2 mm, 1.6 mm, 2.0 mm, and 2.6 mm. After the steps of impregnation, maturation, and drying that are described below, these four substrates will provide catalysts of the same length and diameter, i.e., catalysts in the form of trilobed extrudates with a mean length of 3 mm and mean equivalent diameters respectively of 1.2 mm, 1.6 mm, 2.0 mm, and 2.6 mm.

The impregnation solution was prepared by dissolution in water of molybdenum oxide and cobalt hydroxide in the presence of phosphoric acid at a temperature of 90° C. in such a way as to obtain an MoO₃ content of 17% expressed in terms of oxide form and relative to the dry catalyst mass. After dissolution of the above-mentioned precursors and cooling of the solution, the organic additive was added in such a way as to comply with a citric acid/Mo atomic ratio of 0.5. The solution was then impregnated in the four different substrates by the dry impregnation method. After the impregnation step, the solids that were obtained were matured under a moist atmosphere at ambient temperature for 12 hours and then dried at 120° C. for 24 hours. The shapes, diameters, and lengths of the prepared catalysts are recorded in Table 1. The four catalysts have the same composition of the active phase and are differentiated only by their mean equivalent diameter.

TABLE 1
Shape, Mean Equivalent Diameter and Mean Length of the Catalysts

| Reference | C1 | C2 | C3 | C4 |
|---|---|---|---|---|
| Form of | Trilobed | Trilobed | Trilobed | Trilobed |
| Catalyst | | | | |
| Mean | 1.20 ± 0.03 | 1.61 ± 0.03 | 2.03 ± 0.03 | 2.61 ± 0.03 |
| Equivalent | | | | |
| Diameter | | | | |
| (mm)* ^{and} ** | | | | |
| Mean Length | 3.0 ± 0.3 | 2.9 ± 0.3 | 3.0 ± 0.3 | 3.1 ± 0.3 |
| (mm)* ^{and} ** | | | | |

*Determined by imagery from an average over 250 catalyst grains
**The mean length and the mean equivalent diameter of the substrate and of the catalyst are equal

### Example 2—Comparisons of Catalytic Performances

The performances of the C2 catalyst with a mean equivalent diameter of 1.6 mm that is used by itself (loading A non-compliant with the invention) is compared to a concatenation of the C1 catalyst with a mean equivalent diameter of 1.2 mm and then the C3 catalyst with a mean equivalent diameter of 2 mm in proportions of 33.5%/66.5% by volume or 20%/80% (loadings B and C in accordance with the invention). The performances of a fourth loading, the loading D, have also been evaluated. This loading corresponds to a concatenation of the C1 catalyst with a mean equivalent diameter of 1.2 mm, and then the C4 catalyst with a mean equivalent diameter of 2.6 mm in proportions of 33.5%/66.5% by volume. This last loading D is not in accordance with the invention, with the mean equivalent diameter of the C4 catalyst in the second position in the concatenation of catalysts being 2.17 times greater than the mean equivalent diameter of the C1 catalyst in the first position in the concatenation of the two catalysts.

These catalytic systems have been evaluated in the fixed-bed reactor under the conditions that are recorded in Table 2, conditions that comply with those of the method for hydrotreatment of the vacuum distillates for the FCC (or FCC pretreatment). The feedstock that is retained is a feedstock that has the characteristics that are recorded in Table 3.

TABLE 2
Operating Conditions

| | | |
|---|---|---|
| Pressure | MPa | 6.5 |
| Temperature | ° C. | 375 |
| VVH | h⁻¹ | 1 |
| H₂/HC as Input | Nm³/m³ | 500 |

TABLE 3
Characteristics of the Feedstock Used

| | | |
|---|---|---|
| Sulfur | % m/m | 1.892 |
| Nitrogen | ppm | 1,395 |
| Basic nitrogen | ppm | 347 |
| Initial point of DS | ° C. | 316 |
| 5% by weight of DS | ° C. | 394 |
| 10% by weight of DS | ° C. | 413 |
| 20% by weight of DS | ° C. | 436 |
| 30% by weight of DS | ° C. | 450 |
| 40% by weight of DS | ° C. | 466 |
| 50% by weight of DS | ° C. | 480 |
| 60% by weight of DS | ° C. | 498 |
| 70% by weight of DS | ° C. | 515 |
| 80% by weight of DS | ° C. | 537 |
| 90% by weight of DS | ° C. | 563 |
| 95% by weight of DS | ° C. | 581 |
| Final point of DS | ° C. | 625 |
| TMP | ° C. | 488 |

The results that are obtained in terms of conversion into sulfur and conversion into nitrogen as well as the pressure drop per loading are indicated in Table 4.

It is clearly observed that the loading B corresponding to a concatenation of the C1 catalyst with a mean equivalent diameter of 1.2 mm with the C3 catalyst with a mean equivalent diameter of 2 mm in proportions by volume of 33.5%/66.5% makes it possible to improve the performance of the method with a sulfur content in the effluents at 199 ppm versus 222 ppm or 265 ppm with the respective loadings A or D, i.e., the loading corresponding to 100% of the C2 catalyst with a mean equivalent diameter of 1.6 mm or the loading corresponding to a concatenation of C1 catalyst with a mean equivalent diameter of 1.2 mm with the C4 catalyst with a mean equivalent diameter of 2.6 mm in proportions by volume of 33.5%/66.5%. At the beginning of the bed, the reactions are very fast, and consequently, gas-liquid transfer limitations and internal limitations can arise. The introduction of a catalyst of smaller size makes it possible to reduce these limitations and therefore to increase the catalytic performances. After passing through the fastest reactions, introduction of a catalyst of larger size, in this case the mean equivalent diameter of 2 mm, does not harm the overall performance of the method (in contrast to the catalyst with a mean equivalent diameter of 2.6 mm), and it makes it possible to preserve a satisfactory pressure drop (7,540 Pa/m), similar to the pressure drop that is obtained in the case of the loading A. Thus, the introduction of a catalyst of larger size after the catalyst with a reduced equivalent diameter makes it possible to compensate for the increase in pressure drop that would have been obtained by the use of the catalyst of small size (in this case, 1.2 mm with a mean equivalent diameter) over the entire catalytic bed.

The comparison of the performances of the loading C corresponding to a concatenation of the C1 catalyst with a mean equivalent diameter of 1.2 mm with the C3 catalyst with a mean equivalent diameter of 2 mm in proportions by volume of 20%/80% with those of the loading A, i.e., a loading that corresponds to 100% of the C2 catalyst with a mean equivalent diameter of 1.6 mm, makes it possible to demonstrate the advantage in terms of operability of the method of a concatenation of catalysts in accordance with the invention, since with the loading C, the pressure drop is 7,010 Pa/m, versus 7,540 Pa/m with the loading A, without thereby degrading the hydrodesulfurization and the hydrodenitrification of the method, with the sulfur and nitrogen contents exiting the unit being respectively close to 225 ppm and 350 ppm for the loadings A and C.

TABLE 4
Measured Performances

| | Loading A | Loading B | Loading C | Loading D |
|---|---|---|---|---|
| | (non-compliant) | (compliant) | (compliant) | (non-compliant) |
| % by Volume of C1 Catalyst | 0 | 33.5 | 20 | 33.5 |
| (1.2 mm) | | | | |
| % by Volume of C2 Catalyst | 100 | 0 | 0 | 0 |
| (1.6 mm) | | | | |
| % by Volume of C3 Catalyst | 0 | 66.5 | 80 | 0 |
| (2 mm) | | | | |
| % by Volume of C4 Catalyst | 0 | 0 | 0 | 66.5 |
| (2.6 mm) | | | | |
| Sulfur Exiting Unit (ppm) | 222 | 199 | 227 | 265 |
| Nitrogen Exiting Unit (ppm) | 350 | 334 | 353 | 391 |
| Pressure Drop - Pa/m | 7,540 | 7,540 | 7,010 | 6,845 |

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. Method for hydrotreatment of a hydrocarbon feedstock that contains nitrogen and sulfur compounds with a content that is greater than 250 ppm by weight and that has a weighted mean boiling point that is greater than 380° C., in which, in a way so as to obtain a hydrotreated effluent, said hydrocarbon feedstock is brought into contact, in the presence of hydrogen, with a concatenation of n catalysts, with n being a whole number between 2 and 10, with said catalysts all comprising an amorphous substrate selected from among alumina, silica and silica-alumina, by themselves or in a mixture, and an active phase comprising at least one metal from group VIB and at least one metal from group VIII, with said method being characterized in that the mean equivalent diameters and the mean lengths of the catalysts that are used comply with the following equations:
1.1×d_{eq moy i}≤d_{eq moy i+1}≤2×d_{eq moy i}
l_{moy i}≤l_{moy i+1}≤2×l_{moy i}
d_{eq moy i}≤l_{moy i}
d_{eq moy i+1}≤l_{moy i+1}
in which:
d_{eq moy i}=mean equivalent diameter of the catalyst in the i^{th} position in the concatenation of n catalysts
d_{eq moy i+1}=mean equivalent diameter of the catalyst in the i+1^{th} position in the concatenation of n catalysts
l_{moy i}=mean length of the catalyst in the i^{th} position in the concatenation of n catalysts
l_{moy i+1}=mean length of the catalyst in the i+1^{th} position in the concatenation of n catalysts
with i being a whole number between 1 and n−1.

2. Method according to claim 1, in which the mean equivalent diameters and the mean lengths of the catalysts that are used in the method according to the invention comply with the following equations:
1.1×d_{eq moy i}≤d_{eq moy i+1}≤1.8×d_{eq moy i}
l_{moy i}≤l_{moy i+1}≤1.8×l_{moy i}
d_{eq moy i}≤l_{moy i}
d_{eq moy i+1}≤l_{moy i+1}
with d_{eq moy i}, d_{eq moy i+1}, l_{moy i}, l_{moy i+1} having the above-mentioned definition.

3. Method according to claim 1, in which n=2, i.e., in the case where a concatenation of 2 catalysts is implemented, the mean equivalent diameters and the mean lengths of the catalysts that are used in the method according to the invention comply with the following equations:
1.1×d_{eq moy 1}≤d_{eq moy 2}≤2×d_{eq moy 1}
preferably 1.1×d_{eq moy 1}≤d_{eq moy 2}≤1.8×d_{eq moy 1}
l_{moy 1}≤l_{moy 2}≤2×l_{moy 1}
preferably l_{moy 1}≤l_{moy 2}≤1.8×l_{moy 1}
d_{eq moy 1}≤l_{moy 1}
d_{eq moy 2}≤l_{moy 2}
where:
d_{eq moy 1}=mean equivalent diameter of the catalyst in the 1^{st} position in the concatenation of 2 catalysts
d_{eq moy 2}=mean equivalent diameter of the catalyst in the 2^{nd} position in the concatenation of 2 catalysts
l_{moy 1}=mean length of the catalyst in the 1^{st} position in the concatenation of 2 catalysts
l_{moy 2}=mean length of the catalyst in the 2^{nd} position in the concatenation of 2 catalysts

4. Method according to claim 1, in which said method is implemented in 1 or m reactors, with m being a whole number between 2 and n, with n being the number of catalysts that are used in said concatenation and having the above-mentioned definition.

5. Method according to claim 3, in which when the method is implemented in 1 or 2 reactors, and in the case where said method implements a concatenation of 2 catalysts (n=2), the first catalytic bed that contains the first catalyst occupies a volume V1, and the second catalytic bed that contains the second catalyst occupies a volume V2, with the distribution of the volumes V1/V2 being between 10% by volume/90% by volume and 90% by volume/10% by volume respectively of said first and second catalytic beds.

6. Method according to claim 1, in which when the method is implemented in m reactors, with m having the above-mentioned definition, the effluent that exits from a p^{th} reactor, p being a whole number of between 1 and m−1, is subjected to a separation step that makes it possible to separate a light fraction that contains in particular the H₂S and the NH₃ that are formed during the hydrotreatment that takes place in said p^{th} reactor from a heavy fraction that contains the unconverted hydrocarbons; the heavy fraction that is obtained after the separation step is then introduced into the p+1^{th} reactor of the method.

7. Method according to claim 1, in which for the catalyst(s) used in the concatenation, the metal from group VIB is selected from among molybdenum, tungsten, and the mixture of these two elements, and the metal from group VIII is selected from among cobalt, nickel, and the mixture of these two elements.

8. Method according to claim 1, in which the amorphous substrate of the catalysts that are used in the concatenation is an alumina.

9. Method according to claim 1, in which the catalysts that are used in the concatenation also comprise phosphorus as dopant and/or dopants selected from among boron and fluorine, by itself or in a mixture.

10. Method according to claim 1, in which the n catalysts that are used in the concatenation are additive catalysts and comprise at least one organic compound that contains oxygen or nitrogen and/or sulfur.

11. Method according to claim 1, in which said method is used at a temperature of between 200 and 450° C., at a pressure of between 0.5 and 30 MPa, at an hourly volumetric flow rate of the feedstock in relation to the volume of each catalyst of between 0.2 and 20 h⁻¹ and with a hydrogen/feedstock ratio that is expressed in terms of normal cubic meters (Nm³) of hydrogen per cubic meter (m³) of hydrocarbon feedstock between 50 Nm³/m³ to 2,000 Nm³/m³.

12. Method according to claim 1, in which the hydrotreatment method according to the invention is implemented as pretreatment in a fluidized-bed catalytic cracking method.

13. Method according to claim 1, in which the hydrotreatment method according to the invention is used as pretreatment in a so-called “one-step” hydrocracking method or in a so-called “two-step” hydrocracking method.
